(19) United States
(12) Patent Application Publication
(10) Pub. No.: US 2012/0148108 A1
(43) Pub. Date: Jun. 14, 2012

(54) IMAGE PROCESSING APPARATUS AND METHOD THEREFOR

(75) Inventor: KAZUHIRO YAHATA, Fuchu-shi (JP)

(73) Assignee: CANON KABUSHIKI KAISHA, Tokyo (JP)

(21) Appl. No.: 13/312,117

(22) Filed: Dec. 6, 2011

(30) Foreign Application Priority Data
Dec. 13, 2010 (JP) 2010-277425

(51) Int. Cl. G06K 9/00; H04N 7/18

(52) U.S. Cl. 382/106; 348/135; 348/E07.085

(57) ABSTRACT

Image capturing data captured by using an imaging optical system including an iris with an aperture having no point symmetry is input. An imaging parameter for the imaging optical system when the image capturing data is captured is captured. A spectrum of the input image capturing data is calculated. Optical characteristic information corresponding to an imaging parameter and an object distance and a spectrum model are obtained. A predictive model is generated as a spectrum model corresponding to the input image capturing data by using the imaging parameter, optical characteristic information, and spectrum model. An evaluation function is generated by using the spectrum of the image capturing data and the predictive model. The actual distance of the object included in an image represented by the image capturing data is estimated by using the evaluation function and a statistical method.

### BACKGROUND OF THE INVENTION

1. Field of the Invention

The present invention relates to image processing for estimating the actual distance of an object included in the image represented by image capturing data.

2. Description of the Related Art

In a captured image, the distance (to be referred to as the actual distance of an object hereinafter) between a camera (or lens) and the object is closely related to the shape of a two-dimensional blur of an object image. There is available a technique of estimating the distances at points in a captured image by analyzing the shapes of blurs at the respective points in the captured image based on the relationship between the shape of the blur and the object distance which is the distance between a lens at the time of image capturing and the position where the camera is in focus.

The relationship between the distance and the shape of the blur changes depending on the optical system used. There is known an optical system which allows easy estimation of a distance or an optical system which allows high-accuracy distance estimation. For example, Japanese Patent No. 2963990 (patent literature 1) discloses a technique of estimating the actual distance of an object by using a coded aperture structured to improve the accuracy of a distance estimation result and obtaining a plurality of images at different object distances by splitting light.

In addition, Anat Levin, Rob Fergus, Fred Durand, William T. Freeman “Image and Depth from a Conventional Camera with Coded Aperture” ACM Transactions on Graphics, Vol. 26, No. 3, Articles 70, 2007/07 (non-patent literature 1) discloses a technique of estimating a distance from one image captured by using a coded aperture. Furthermore, non-patent literature 1 discloses the finding that using a coded aperture having a symmetric shape will improve distance estimation accuracy.

The technique disclosed in patent literature 1 simultaneously captures a plurality of images by splitting light, and hence requires a plurality of image sensing devices, in addition to each captured image being dark. In contrast to this, the technique disclosed in non-patent literature 1 captures only one image at a time, and hence is free from the drawback in patent literature 1.

The distance estimation technique disclosed in non-patent literature 1 does not sufficiently use the distance information included in a captured image. For this reason, the accuracy of the estimation of the actual distance of an object is not sufficiently high. In addition, owing to capturing only one image and its processing technique, it is difficult to identify two distances, smaller and larger than the object distance, at which the shapes of blurs are almost the same. In other words, this technique can accurately estimate the actual distance of an object included in a captured image only when the object is located at a position corresponding to a distance shorter or longer than the object distance.

### SUMMARY OF THE INVENTION

In one aspect, an image processing apparatus comprises: an inputting section, configured to input image capturing data captured by using an imaging optical system including an iris with an aperture having no point symmetry; an obtaining section, configured to obtain an imaging parameter for the imaging optical system when the image capturing data is captured; a calculator, configured to calculate a spectrum of the input image capturing data; a storing section, configured to store optical characteristic information of the imaging optical system and a spectrum model of image capturing data; a model generator, configured to generate a predictive model as a spectrum model corresponding to the input image capturing data by using the imaging parameter, optical characteristic information corresponding to the imaging parameter and an object distance, and the spectrum model; a function generator, configured to generate an evaluation function by using the spectrum of the image capturing data and the predictive model; and an estimator, configured to estimate an actual distance of the object included in an image represented by the image capturing data by using the evaluation function and a statistical method.

According to the aspect, it is possible to accurately estimate the actual distance of an object from image capturing data.

Further features of the present invention will become apparent from the following description of exemplary embodiments with reference to the attached drawings.

### BRIEF DESCRIPTION OF THE DRAWINGS

FIG. 1 is a block diagram for explaining the arrangement of an image processing apparatus according to an embodiment.

FIG. 2 is a block diagram for explaining the arrangement of a signal processing unit.

FIGS. 3A to 3E are views each for explaining an example of an aperture without point symmetry.

FIGS. 4A to 4E are views each for explaining a relationship between PSFs and apertures without point symmetry.

FIGS. 5A to 5E are views for explaining MTF patterns.

FIG. 6 is a view for explaining the spectrum of a captured image.

FIG. 7 is a block diagram for explaining the arrangement of a distance estimation unit.

FIGS. 8A and 8B are flowcharts for explaining the processing performed by the distance estimation unit.

FIG. 9 is a view for explaining region segmentation.

FIG. 10 is a graph showing the dependence of the absolute values of spectra on the wave numbers of a plurality of captured images obtained in a state in which the depth of field is very large.

FIG. 11 is a view for explaining the magnitude of a frequency spectrum.

### DESCRIPTION OF THE EMBODIMENTS

Image processing according to the embodiments of the present invention will be described in detail below with reference to the accompanying drawings.

### First Embodiment

### [Apparatus Arrangement]

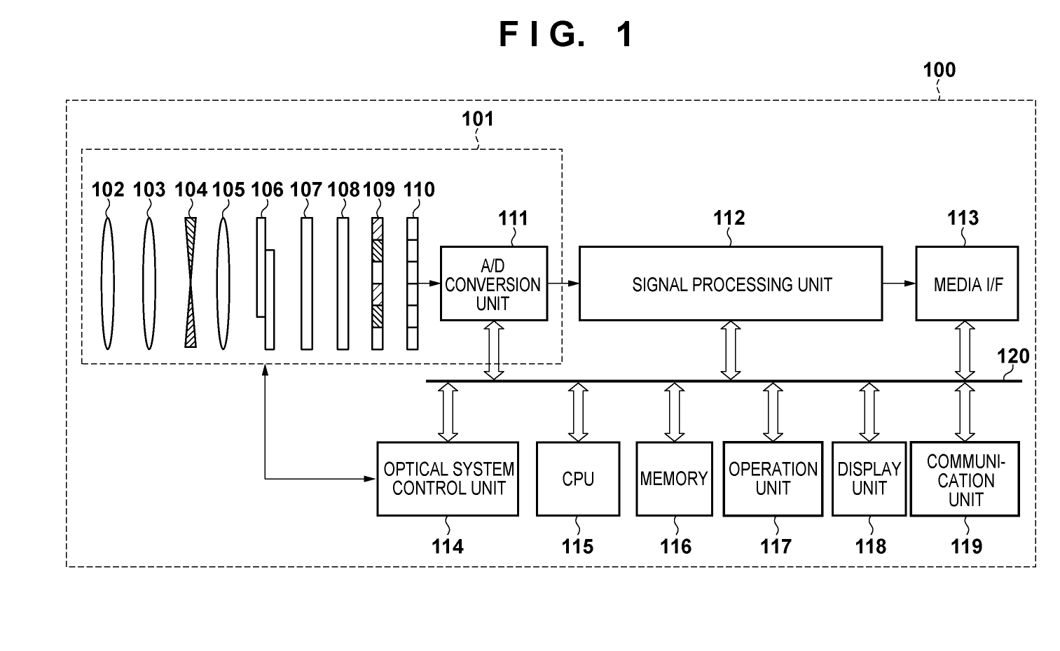

The arrangement of an image processing apparatus according to an embodiment will be described with reference to the block diagram of FIG. 1.

An image sensing apparatus 100 is an image processing apparatus according to an embodiment, which generates a digital image including an object and a distance image indicating the actual distance of the object at each portion in the digital image.

A focus lens group 102 in an imaging optical system 101 is a lens group which adjusts the focus of the imaging optical system 101 (brings it into focus) by moving back and forth on the optical axis. A zoom lens group 103 is a lens group which changes the focal length of the imaging optical system 101 by moving back and forth on the optical axis. An iris 104 is a mechanism for adjusting the amount of light passing through the imaging optical system 101. The details of the iris in this embodiment will be described later. A fixed lens group 105 is a lens group for improving lens performance such as telecentricity.

A shutter 106 is a mechanism that transmits light during exposure and blocks light during other periods. An IR cut filter 107 is a filter which absorbs infrared light (IR) contained in light passing through the shutter 106. An optical low-pass filter 108 is a filter for preventing the occurrence of moire fringes in a captured image. A color filter 109 is a filter which transmits only light in a specific wavelength region. For example, this filter is constituted by R, G, and B filters having a Bayer arrangement.

An image sensing device 110 is an optical sensor such as a CMOS sensor or charge-coupled device (CCD), which outputs an analog signal indicating the amount of light which has passed through the color filter 109 and struck the image sensing elements. An analog/digital (A/D) conversion unit 111 generates image capturing data (to be referred to as RAW data hereinafter) by converting the analog signal output from the image sensing device 110 into a digital signal. Although described in detail later, a signal processing unit 112 generates digital image data by performing demosaicing processing and the like for the RAW data output from the A/D conversion unit 111. A media interface (I/F) 113 records the digital image data output from the signal processing unit 112 on a recording medium such as a memory card which is detachably loaded in, for example, the image sensing apparatus 100.

An optical system control unit 114 controls the imaging optical system 101 to implement focus adjustment, zoom setting, iris setting, shutter opening/closing, and sensor operation. The optical system control unit 114 outputs signals (to be referred to as imaging parameters hereinafter) representing the set state and operation state of the imaging optical system 101, such as an object distance, zoom setting, iris setting, shutter setting, and sensor setting, in accordance with the control of the imaging optical system 101. Note that the imaging optical system 101 may incorporate the optical system control unit 114.

A microprocessor (CPU) 115 executes programs stored in the read only memory (ROM) of a memory 116 and the like by using the random access memory (RAM) of the memory 116 as a work memory to control the respective components and execute various control operations and various processes via a system bus 120. The following is an example in which the signal processing unit 112 performs distance estimation processing. However, the CPU 115 may perform distance estimation processing.

The memory 116 holds information such as programs executed by the CPU 115, the imaging parameters output from the optical system control unit 114, optical characteristic information used for distance estimation processing, and noise parameters for the image sensing apparatus 100. Note that optical characteristic information depends on colors, imaging parameters, and object distances. Noise parameters depend on the ISO sensitivity and pixel values of the image sensing apparatus 100.

An operation unit 117 corresponds to the release button, various setting buttons, mode dial, cross button (none are shown) of the image sensing apparatus 100. The user inputs instructions to the CPU 115 by operating the buttons and dial of the operation unit 117. A display unit 118 is a liquid crystal device (LCD) or the like which displays, for example, display images corresponding to a graphical user interface (GUI) and captured images. A communication unit 119 communicates with external devices such as a computer device and printer via a serial bus interface such as a USB (Universal Serial Bus) and a network interface.

Signal Processing Unit

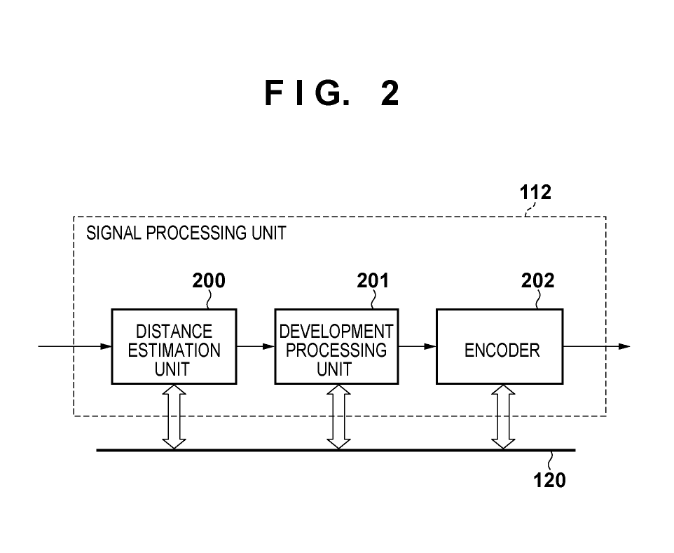

The arrangement of the signal processing unit 112 will be described with reference to the block diagram of FIG. 2.

Although described in detail later, a distance estimation unit 200 performs distance estimation processing by using the RAW data output from the A/D conversion unit 111. A development processing unit 201 generates digital image data by performing development processing and image processing such as demosaicing, white balance adjustment, gamma correction, and sharpening. An encoder 202 converts the digital image data output from the development processing unit 201 into data in a file format such as JPEG (Joint Photographic Experts Group), and adds imaging parameters as Exif (exchangeable image file format) data to an image data file.

Iris

The aperture of the iris 104 is structured to facilitate the estimation of the actual distance of an object, and has a shape which is point asymmetric to all the points on the iris 104. In other words, the iris 104 has an aperture shaped to avoid point symmetry as much as possible. There is no need to use a single iris. The imaging optical system 101 incorporates a plurality of irises (not shown) in addition to the iris 104. These irises may form a point-asymmetric aperture as a whole. Note that an aperture having such a structure will be referred to as a “coded aperture”. In addition, it is possible to perform the same processing regardless of whether the imaging optical system incorporates a single or a plurality of irises. The following description will be made regardless of the number of irises used.

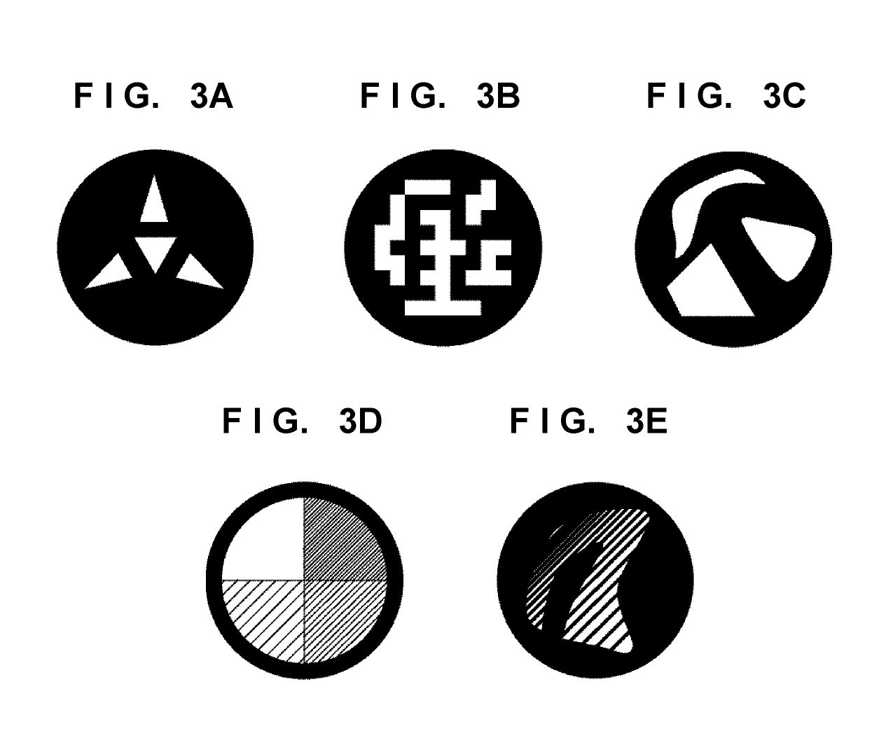

Examples of point-asymmetric apertures will be described with reference to FIGS. 3A to 3E. FIGS. 3A and 3B show examples of apertures formed by aggregates of polygons. FIG. 3C shows an example of an aperture formed by an aggregate of unspecified shapes. FIG. 3D shows an example of an aperture formed by an aggregate of regions having different transmittances. FIG. 3E shows an example of an aperture formed by a thin glass material having gradation of transparency. These aperture arrangements are examples, and the present invention is not limited to the arrangements of the apertures shown in FIGS. 3A to 3E.

### [Image Capturing Processing]

When the user operates the operation unit 117, the CPU 115 receives information corresponding to the operation. The CPU 115 interprets input information and controls the respective units described above in accordance with the interpretation. When, for example, the user performs the operation of changing the zoom, focus, or the like, the CPU 115 transmits a control signal to the optical system control unit 114. The optical system control unit 114 controls the imaging optical system 101 so as to move each lens group in accordance with the control signal. The optical system control unit 114 returns imaging parameters changed by moving each lens group to the CPU 115. The CPU 115 records the received imaging parameters on the memory 116.

When the user presses the shutter button of the operation unit 117, the CPU 115 transmits a control signal for opening the shutter 106 for a predetermined period of time to the optical system control unit 114. The optical system control unit 114 controls the imaging optical system 101 so as to open the shutter 106 for the predetermined period of time in accordance with the control signal. Upon transmitting the control signal, the CPU 115 controls the A/D conversion unit 111, reads out RAW data, and inputs the readout RAW data to the signal processing unit 112. In addition, the CPU 115 reads out imaging parameters, noise parameters, and optical characteristic information from the memory 116 and inputs them to the signal processing unit 112. The signal processing unit 112 performs distance estimation processing, development processing, and encoding by using the input RAW data, imaging parameters, noise parameters, and optical characteristic information. The media I/F 113 stores the digital image data obtained by the above series of processing operations in a recording medium.

### [Distance Estimation Processing]

Outline of Distance Estimation Processing

Distance estimation processing in this embodiment is divided into two stages.

First of all, this apparatus estimates the actual distances of an object by using the statistical characteristics of the absolute values of the spectrum of a photographic image in two intervals shorter and longer than the object distance, and narrows down distance candidates into two. This processing is processing (first processing) for obtaining a good estimation result on the actual distance of the object.

The apparatus divides the captured image spectrum by an optical transfer function (OTF) corresponding to each of the two distance candidates to recover each spectrum changed (blurred) by the imaging optical system 101. The apparatus then selects one of the two distance candidates, which is statistically more suitable for the photographic image, as the actual distance of the object by using statistics with consideration of the phases of the recovered spectra (second processing).

Principle of First Processing

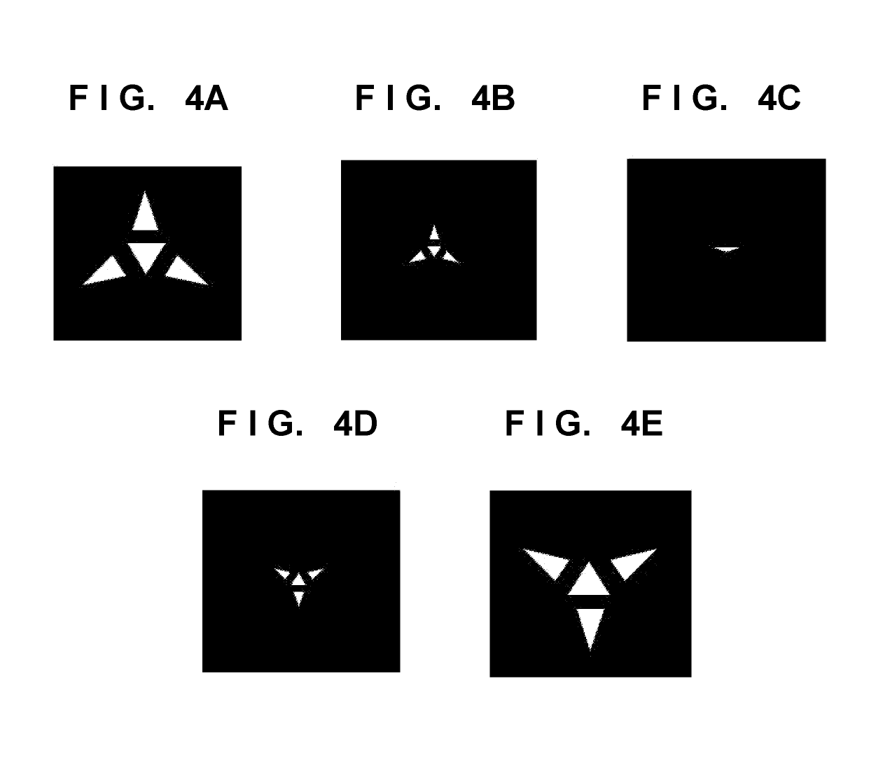

The relationship between PSFs and apertures without point symmetry will be described with reference to FIGS. 4A to 4E. If the iris 104 has an aperture without point symmetry, the shape of a blur, that is, a point spread function (PSF), reflects the shape of the aperture. If, for example, the iris 104 having the aperture shown in FIG. 3A is used, the PSFs shown in FIGS. 4A to 4E are obtained. The differences between FIGS. 4A to 4E indicate the differences in the actual distance of the object.

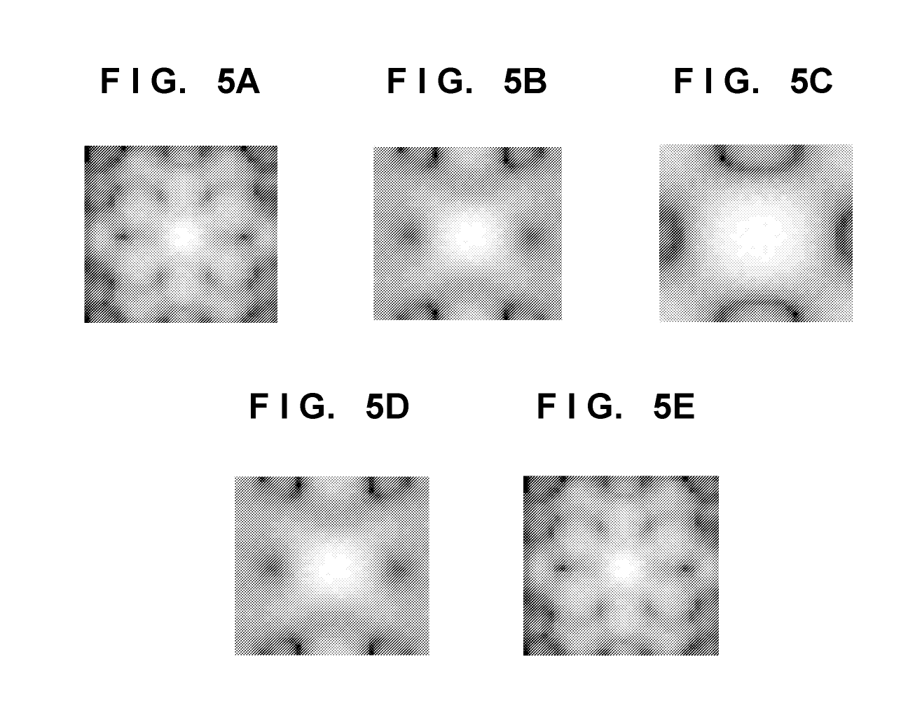

The absolute values of OTFs obtained by Fourier transform of the PSFs shown in FIGS. 4A to 4E, that is, the modulation transfer functions (MTFs), are not monotone functions but have special patterns with respect to frequencies. The patterns of MTFs will be described with reference to FIGS. 5A to 5E. The MTFs shown in FIGS. 5A to 5E respectively correspond to the PSFs shown in FIGS. 4A to 4E, and the MTF patterns depend on the actual distance of the object.

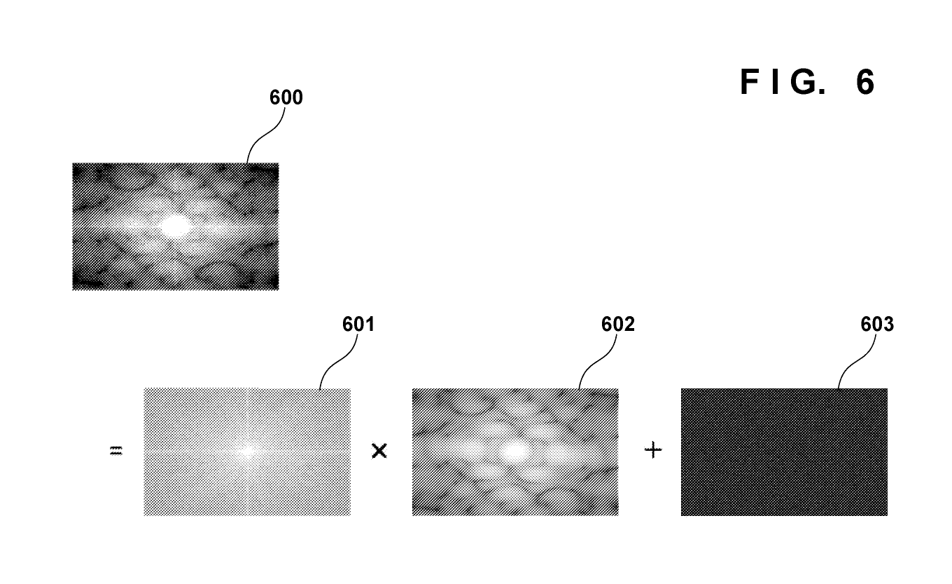

The spectrum of a captured image will be described with reference to FIG. 6. As shown in FIG. 6, a spectrum 600 of a captured image is obtained by adding noise 603 to the product of a spectrum 601 of the object before passing through the imaging optical system 101 and an OTF 602. In other words, the pattern of the OTF 602 corresponding to the actual distance of the object is embedded in the spectrum 600 of the captured image. That is, the first processing (narrowing down distance candidates to two) described above is the processing of detecting the pattern of the OTF 602 embedded in the spectrum 600 of the captured image and determining the actual distance of the object corresponding to the detected pattern.

The technique disclosed in non-patent literature 1 estimates the actual distance of an object without directly using the pattern embedded by a coded aperture. First of all, the apparatus generates an image (to be referred to as a recovered image hereinafter) by removing a blur from a captured image by applying decomposition to the captured image based on the MAP (maximum a posteriori) method using PSFs corresponding to the various actual distances of the object. The apparatus then generates a blur image by performing convolution of the recovered image and the PSFs used for the deconvolution. The apparatus then compares the blur image with the captured image, and sets the distance exhibiting the highest degree of match as the actual distance of the object.

If blur recovery processing is pure deconvolution, convolution restores the recovered image to the captured image. The above comparison produces no difference due to the distances. However, blur recovery processing based on the MAP method includes processing which avoids the occurrence of a striped pattern called ringing in an image after blur recovery unlike pure deconvolution. For this reason, a recovered image is not restored to a captured image by convolution.

Ringing tends to occur when the actual distance of an object differs from a distance corresponding to the PSF used for deconvolution. When considering a frequency space, blur recovery processing is the operation of dividing the spectrum of a captured image by an OTF. An OFT includes a frequency called a “down to zero” frequency whose absolute value becomes minimum. If the actual distance of an object does not match the distance used for blur recovery, frequencies at which “down to zero” occurs do not match in most cases. Since the divisor in blur recovery processing at a frequency at which “down to zero” occurs is the minimum value, the absolute value of the frequency in a recovered image becomes abnormally large, resulting in ringing.

As described above, the technique disclosed in non-patent literature 1 is the processing of detecting ringing due to a mismatch between distances. In other words, the technique disclosed in non-patent literature 1 pays attention only to a portion of the pattern embedded in the spectrum of a captured image at which “down to zero” has occurred.

The portion where “down to zero” has occurred is just a small portion as compared with the overall pattern. On the other hand, distance information is embedded in not only a frequency at which “down to zero” occurs but also the entire frequency region, that is, the entire pattern. This embodiment uses the entire usable frequency region, that is, the entire pattern in which the spectrum of a captured image is embedded, to estimate the actual distance of the object with higher accuracy.

This embodiment uses the entire pattern embedded in the spectrum of a captured image, and hence uses a statistical model of the spectrum of a photographic image. The embodiment then creates a predictive model for the absolute value of the spectrum of a captured image in consideration of the statistical model, the optical characteristics of the imaging optical system 101, and the noise characteristics of the image sensing apparatus 100. As described above, the optical characteristics of the imaging optical system 101 depend on at least the object distance. Consequently, the predictive model also depends on the object distance. The embodiment then compares the predictive model with the absolute value of the spectrum of the actual captured image, and sets, as an actual distance candidate of the object, the distance exhibiting the highest degree of match.

According to the estimation method of this embodiment, it is possible to estimate the actual distance of the object with high accuracy. If the noise contained in a captured image is small, it is possible to set a candidate of the actual distance of an object which is derived from the first processing as the final estimation result. If the noise contained in a captured image is large, it is difficult to determine whether the object is located at a position corresponding to a distance shorter or longer than the object distance, by only the first processing of estimating the actual distance of the object by using the absolute value of the spectrum of the captured image.

In order to obtain an estimation result with high reliability even if large noise is contained in a captured image, this apparatus performs the first processing to determine one candidate of the actual distance of the object at each of positions corresponding to distances shorter and longer than the object distance, and performs the second processing to select one candidate. In other words, the first processing is only required to determine candidates of the actual distance of an object shorter or longer than the object distance. For example, it is possible to use the technique disclosed in non-patent literature 1, which includes a coded aperture having point symmetry.

Principle of Second Processing

As described above, it is difficult to determine whether an object is located at a position corresponding to a distance shorter or longer than the object distance, by the processing using the absolute value of the spectrum of a captured image like the technique disclosed in non-patent literature 1 or the first processing. This is because there are a pair of points including an arbitrary point at a position corresponding to a distance longer than the object distance and a corresponding point at a position corresponding to a distance shorter than the object distance, and the shape of a PSF at one point is almost the same as that of a PSF at the other point which is obtained by rotating (reversing) the PSF about a given point through 180°.

For example, when one of the pair of PSFs shown in FIGS. 4A and 4E or FIGS. 4B and 4D is reversed, the resultant shape becomes almost the same as that of the other PSF. In the case of an ideal optical system without any aberration, when any one of PSFs located at positions corresponding to distances shorter and longer than an object distance is reversed about a given point, the shapes of these PSFs perfectly match each other.

OTFs corresponding to two PSFs having such a point symmetric relationship have the same absolute value and values having opposite phase signs. That is, information indicating positions corresponding to distances shorter and longer than an object distance exists only in phases. Therefore, the absolute value of the spectrum of a captured image includes no information that indicates positions corresponding to distances shorter and longer than the object distance. In other words, it is necessary to determine the anteroposterior relationship with the object distance based on the phase of the spectrum of a captured image. As described above, in the case of an ideal optical system without aberration, it is impossible, in principle, to determine the anteroposterior relationship with the object distance by the processing using the absolute value of the spectrum of the captured image.

An actual optical system (lens) has slight aberration, and hence PSFs at positions corresponding to distances shorter and longer than an object distance do not completely match. Therefore, some possibility is left to determine the anteroposterior relationship with the object distance. However, since the difference between the PSFs due to slight aberration is small, it is difficult to discriminate the difference between the PSFs due to noise, and it is difficult to determine the anteroposterior relationship with the object distance.

Non-patent literature 1 discloses the finding that an iris with an aperture having high symmetry causes “down to zero” frequently, and the accuracy of the estimation of the actual distance of an object tends to be high. In practice, therefore, this technique estimates the actual distance of the object by using a point-symmetric aperture.

The shape of an aperture obtained by reversing a point-symmetric aperture with respect to a point of symmetry match the shape of the aperture before reversal. For this reason, PSFs to be discriminated become identical at positions corresponding to distances shorter and longer than the object distance, and OTFs also become identical. That is, it is impossible to determine the anteroposterior relationship with the object distance even by using phase information. Even in the presence of aberration, the accuracy of determination on the anteroposterior relationship with the object distance by using phase information is low. In consideration of this point, this embodiment uses an aperture (coded aperture) without point symmetry.

When considering the phase information of the spectrum of an image captured by using a point-asymmetric aperture, it is possible to determine the anteroposterior relationship with the object distance. In order to properly estimate the actual distance of an object, it is necessary to not only find a difference due to distances but also determine which is correct. This apparatus therefore performs the above determination by using the statistical characteristics of the phase of the spectrum of a photographic image.

In general, a photographic image has edges including those constituting fine texture. An edge portion generally includes signals having various frequencies. Their phases are not randomly distributed but have an autocorrelation. The apparatus therefore performs the above determination based on the intensity of the autocorrelation.

First of all, the apparatus performs blur recovery processing by dividing the captured image by OTFs corresponding to the two distance candidates determined in the first processing. The apparatus then calculates binary autocorrelations of the phases of the spectra of the two recovered images, and obtains the sum of the absolute values of the binary autocorrelations throughout all the frequencies. A distance candidate corresponding to the larger sum is set as an estimation result on the actual distance of the object. This makes it possible to accurately determine whether the actual distance of the object is shorter or longer than the object distance.

Although the technique of evaluating the binary correlation of phases has been exemplified as a statistical method, it is possible to perform similar determination by using any statistics obtained in consideration of phases. For example, it is also possible to determine the anteroposterior relationship with the object distance by using the power spectrum of phase having a Fourier transform relationship with binary autocorrelation. In addition, it is possible to use high-order statistics such as triadic autocorrelation or bispectrum of a captured image.

### [Distance Estimation Unit]

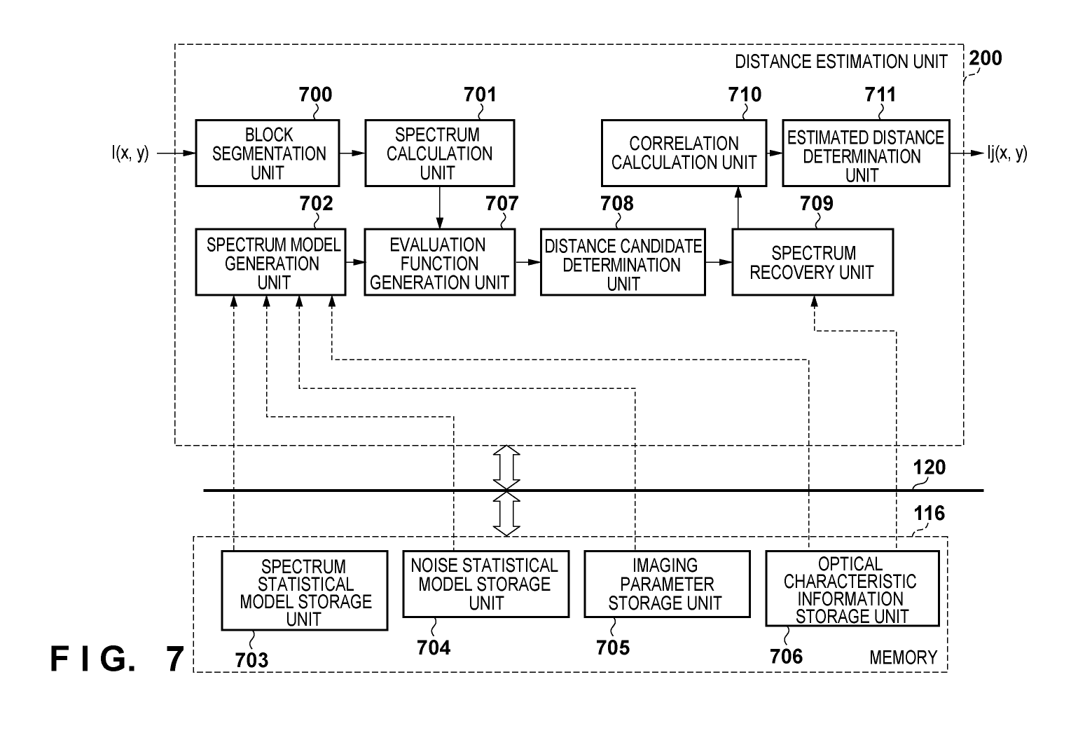

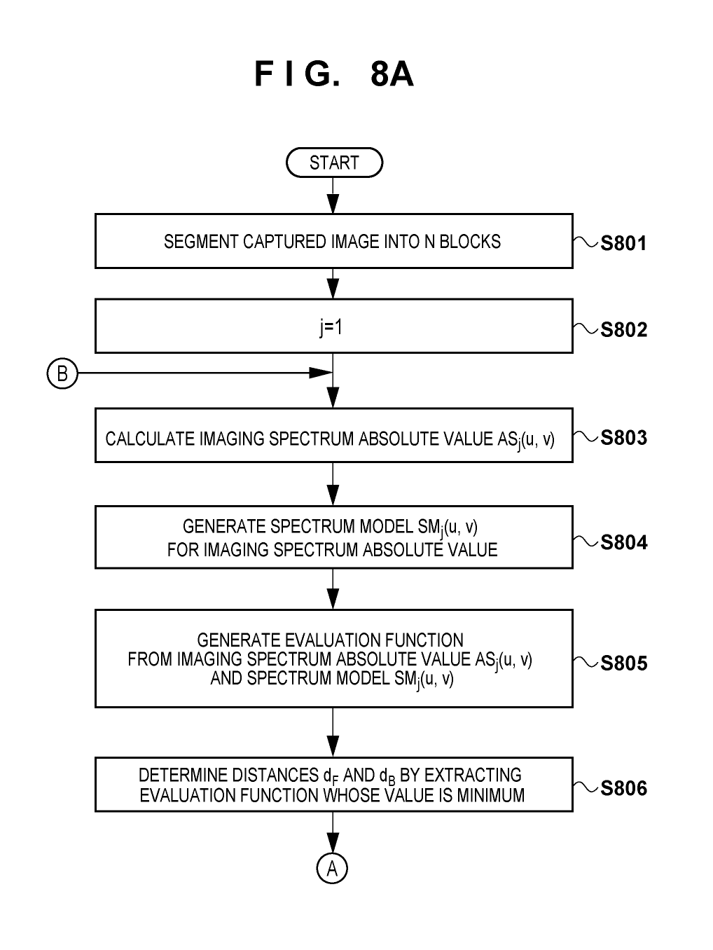

The arrangement of the distance estimation unit 200 will be described with reference to the block diagram of FIG. 7. The processing performed by the distance estimation unit 200 will be described with reference to FIGS. 8A and 8B. The following is a case in which the distance estimation unit 200 receives the RAW data output from the A/D conversion unit 111 and performs distance estimation processing. The distance estimation unit 200 can also perform distance estimation processing by receiving the digital image data output from the development processing unit 201.

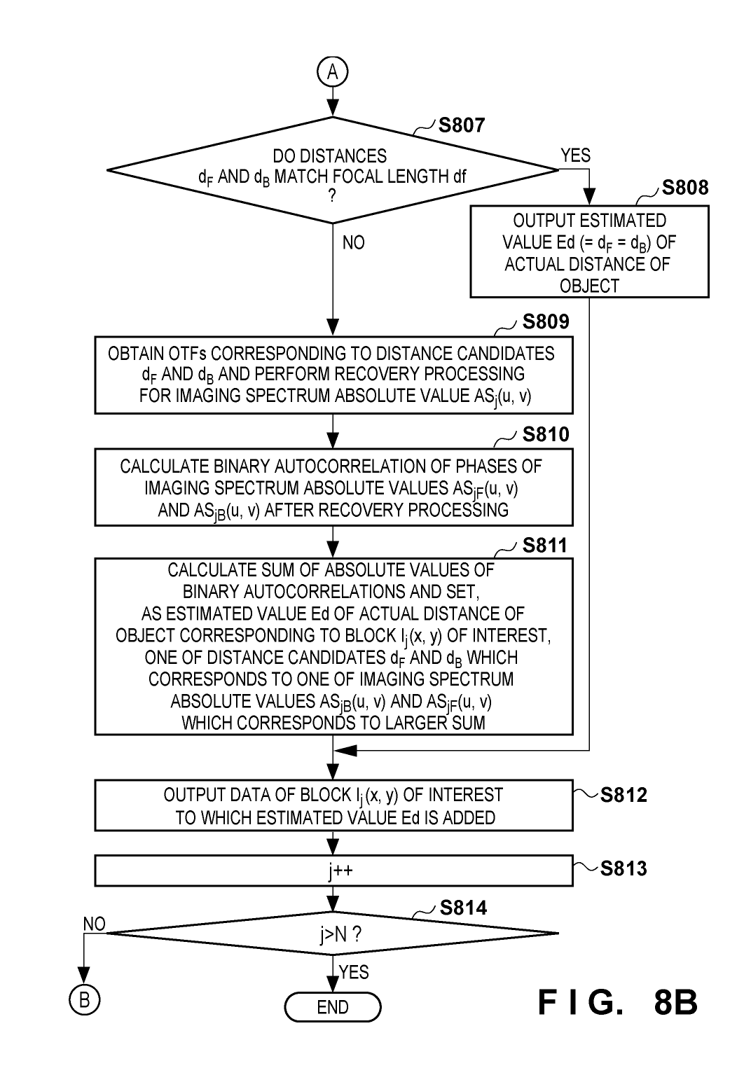

A block segmentation unit 700 segments an image (to be referred to as a captured image hereinafter) represented by the RAW data into N blocks (S801), and sets counter j=1 (S802). Segmenting operation will be described with reference to FIG. 9. As shown in FIG. 9, a captured image I(x, y) is segmented into N blocks I₁(x, y), I₂(x, y), . . . , Iⱼ(x, y), . . . , I_{N}(x, y). Note that (x, y) represents the x- and y-coordinates of a pixel (image sensing element) of a captured image. The following processing is performed for each block.

A spectrum calculation unit 701 multiplies an image in the block Iⱼ(x, y) of interest by a window function W(x, y), performs Fourier transform of the product, and calculates the absolute value (to be referred to as an imaging spectrum absolute value ASⱼ(u, v) hereinafter) of the spectrum of the captured image (S803). Note that u and v represent coordinates in the frequency space after Fourier transform, which respectively correspond to the x- and y-axes.

Although described in detail later, a spectrum model generation unit 702 generates a predictive model SMⱼ(u, v) corresponding to the imaging spectrum absolute value ASⱼ(x, y) (S804). At this time, the spectrum model generation unit 702 uses a statistical model (to be referred to as a spectrum statistical model hereafter) corresponding to the absolute value of the spectrum of a photographic image, the optical characteristics of the imaging optical system 101, distances, the noise characteristics of the image sensing apparatus 100, and the like.

The memory 116 has an area storing information necessary for the spectrum model generation unit 702 to calculate a predictive model. A spectrum statistical model storage unit 703 stores a spectrum statistical model. A noise statistical model storage unit 704 stores a statistical model of noise in the image sensing apparatus 100. An imaging parameter storage unit 705 stores imaging parameters for a captured image. An optical characteristic information storage unit 706 stores optical characteristic information corresponding to imaging parameters. The details of a statistical model and the like will be described later.

Although described in detail later, an evaluation function generation unit 707 generates an evaluation function from the imaging spectrum absolute value ASⱼ(x, y) and the predictive model SMⱼ(u, v) (S805). A distance candidate determination unit 708 extracts evaluation functions with the minimum values with respect to distances shorter and longer the object distance, which include the actual distance of the object, and determines distances d_{F} and d_{B} from the extracted evaluation functions (S806). The distances d_{F} and d_{B} are two candidates of the actual distance of the object.

The distance candidate determination unit 708 determines whether the two distance candidates d_{F} and d_{B} match an object distance df (S807). If they match each other, the distance candidate determination unit 708 outputs df=d_{F}=d_{B} as an estimated value Ed of the actual distance of the object corresponding to the block Iⱼ(x, y) of interest to an estimated distance determination unit 711 (S808). The process then advances to step S812. Note that it is not necessary to strictly determine whether given distances match the object distance df, and it is possible to perform this determination according to, for example, the following expression:

if ((df/β<d_{F}≦df)&&(df≦d_{B}<df·β))

match;

else

mismatch; (1)

where a coefficient β is a fixed value (for example, 1.1) or a function of a depth of field, and

&& represents an AND operator.

If the two distance candidates d_{F} and d_{B} do not match the object distance df, a spectrum recovery unit 709 obtains OTFs respectively corresponding to the distance candidates d_{F} and d_{B} from the optical characteristic information storage unit 706. The spectrum recovery unit 709 then performs blur recovery processing by dividing the imaging spectrum absolute value ASⱼ(u, v) by the obtained OTFs (S809).

A correlation calculation unit 710 calculates the binary autocorrelations of the phases of imaging spectrum absolute values AS_{jF}(u, v) and AS_{jB}(u, y) after the recovery processing (S810). The estimated distance determination unit 711 calculates the sums of the absolute values of the respective binary autocorrelations, and compares the sum corresponding to the imaging spectrum absolute value AS_{jF}(u, v) with the sum corresponding to the imaging spectrum absolute value AS_{jB}(u, v). The estimated distance determination unit 711 then determines, as the estimated value Ed of the actual distance of the object corresponding to the block Iⱼ(x, y) of interest, one of the distance candidates d_{F} and d_{B} corresponding to the imaging spectrum absolute values AS_{jF}(u, v) and AS_{jB}(u, v) which corresponds to a larger sum (S811).

The estimated distance determination unit 711 outputs the data of the block Iⱼ(x, y) of interest to which the determined estimated value Ed is added (S812). Note that if the two distance candidates match the object distance, estimated value Ed=d_{F}=d_{B}. The estimated distance determination unit 711 then increments the counter j (S813), and determines the count value of the counter j (S814). If j≦N, the process returns to step S803. If j>N, the estimated distance determination unit 711 terminates the processing. Note that the estimated value Ed of the actual distance of the object is used for a distance image.

Processing Performed by Spectrum Model Generation Unit and Evaluation Function Generation Unit

The processing (S804, S805) performed by the spectrum model generation unit 702 and the evaluation function generation unit 707 is repeatedly performed for the following parameters:

the range of the actual distances of an object in which a predictive model is generated;

noise parameters for the noise amount of the image sensing apparatus 100; and

variables of model parameters used by a spectrum statistical model corresponding to an imaging spectrum absolute value before blurring by the imaging optical system 101.

Spectrum Statistical Model

Although an imaging spectrum absolute value before blurring by the imaging optical system 101 is a conceptual value, this value can be regarded as almost equal to the imaging spectrum absolute value captured in a state in which the depth of field is very large. It is not always necessary for a spectrum statistical model to use only one model parameter, and it is possible to use a plurality of model parameters as long as they can effectively express an imaging spectrum absolute value before blurring.

In addition, model parameters need not be continuous values, and may be indices that discriminate imaging spectrum absolute values with different shapes. In this case, however, the spectrum statistical model storage unit 703 stores statistical models of imaging spectrum absolute values, and supplies them to the distance estimation unit 200 at the start of distance estimation processing.

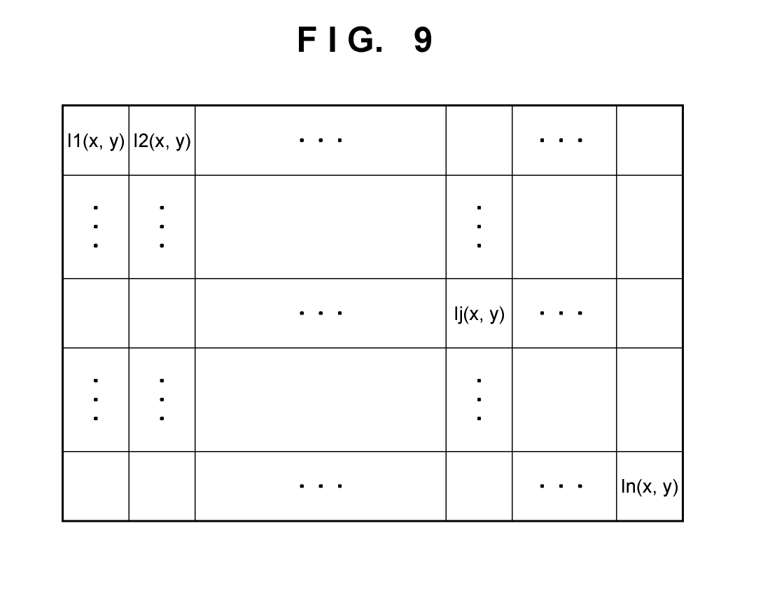

A spectrum statistical model is constructed by obtaining the absolute values of the spectra of many captured images, observing them, and checking their statistical characteristics. FIG. 10 shows the dependence of the absolute values of spectra on wave numbers k of a plurality of captured images obtained in a state in which the depth of field is very large. Referring to FIG. 10, the abscissa represents the wave number k calculated by equation (2) (to be described later), and the ordinate represents the absolute value of a spectrum. As shown in FIG. 10, when the depth of field is large, observing the absolute values of the spectra of a plurality of captured images with a double logarithmic chart will reveal that all the values become almost linear. Based on such statistical characteristics, in this embodiment, a spectrum statistical model corresponding to an imaging spectrum absolute value AS_{org}(u, v) before blurring is defined as follows.

First, an expected value <AS_{org}(u, v)> at a frequency (u, v) is defined as a power function with the magnitude of a frequency vector being a base. Note however that the magnitude of this frequency vector is derived in consideration of the aspect ratio of an image. If, for example, an image is constituted by square pixels and the length of the image in the x direction is α times that in the y direction, a magnitude k of a frequency vector is calculated by

k=1+√(u²+(v/α)²) (2)

where u and v represent a pixel position in the spectrum image after Fourier transform.

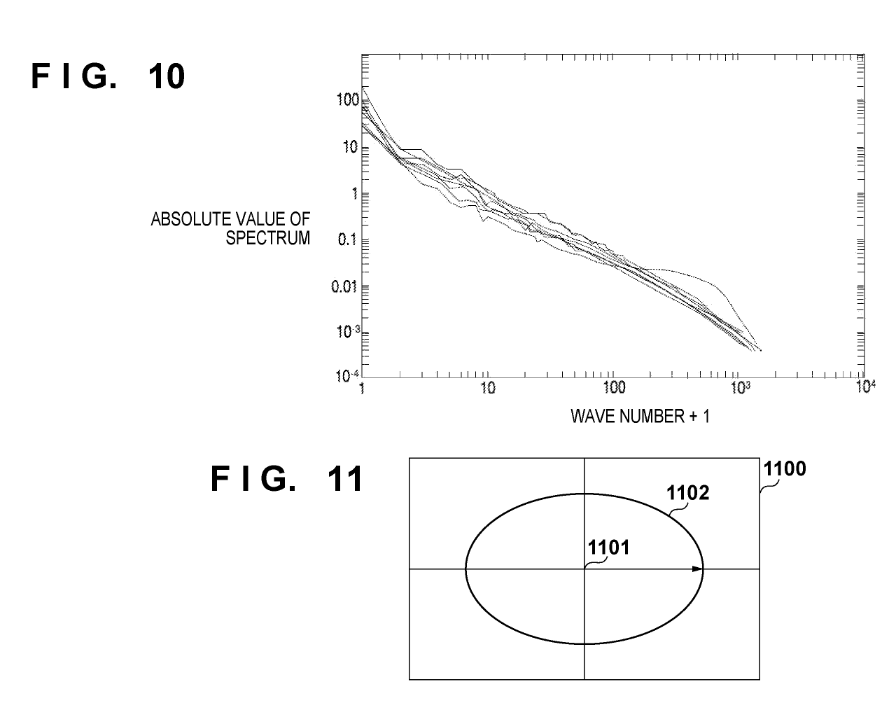

The magnitude k of the frequency vector will be described with reference to FIG. 11. Reference numeral 1100 denotes a spectrum image after Fourier transform; 1101, the position of a DC component of the spectrum; and 1102, the locus of the positions where the magnitude k of the frequency vector, which is calculated by equation (2), is constant. As shown in FIG. 11, the locus 1102 is an ellipse having the same ratio (major axis/minor axis) as the aspect ratio of the image.

Second, an exponent γ of the power function and a proportionality coefficient k₀ applied to the overall function are model parameters. These model parameters are variables which differ for each image.

Third, the values at the respective frequencies follow a logarithmic normal distribution, and a standard deviation σₘ of the values is set as a model parameter. The standard deviation σₘ is a constant which depends on neither frequency nor image. The standard deviation σₘ is irrelevant to the repetition of the processing (S804, S805) performed by the spectrum model generation unit 702 and the evaluation function generation unit 707.

The spectrum statistical model defined in the above manner is an example. For example, the above spectrum statistical model may be expanded so as to make the exponent γ have moderate frequency dependence or make the standard deviation σₘ have image dependence or frequency dependence. Although it is possible to introduce more model parameters, the number of model parameters must not exceed the number of pixels constituting a block. In addition, even if the number of model parameters does not exceed the number of pixels, an excessive increase in the number of model parameters may increase the calculation cost and decrease the determination accuracy of distance candidates.

Alternatively, a spectrum statistical model may be expanded such that spectrum statistical models are respectively prepared for different image capturing scenes such as night scenes, marine scenes, city scenes, indoor scenes, nature scenes, portrait scenes, and underwater scenes. It is possible to separately discriminate image capturing scenes by a known method. Then, the spectrum statistical model is selected based on the determined image capturing scenes to be used. Note that the spectrum statistical model storage unit 703 holds some of model parameters which are constants.

Noise Statistical Model

White noise is assumed as noise in this case. Assume that the absolute values of noise spectra follow a normal distribution with an average N and a standard deviation σ_{N}. The average N of noise is a noise parameter, and the standard deviation σ_{N} of noise is a constant. This is an example of a noise model. It is therefore possible to use a more precise noise model in accordance with the image sensing apparatus 100 or an image. Note that the noise statistical model storage unit 704 holds some of noise parameters which are constants.

Range of Actual Distances of Object The range of the actual distances of an object in which a predictive model is generated may directly set as the estimation range of the actual distances of the object. The range in which model parameters are changed depends on a spectrum statistical model to be used. When determining a spectrum statistical model from the spectra of many captured images, the apparatus sets, as a range in which model parameters are changed, a range obtained by checking in advance how much the respective model parameters are changed. For example, in the above spectrum statistical model, it is sufficient to change the exponent γ from 0 to about 2.5. In addition, it is sufficient to change the proportionality coefficient k₀ from 1 to the maximum pixel value (for example, 1023 if RAW data is 10-bit data). Furthermore, the range in which noise parameters are changed is determined from the noise characteristics of the image sensing apparatus 100.

Spectrum Model Generation Unit

The spectrum model generation unit 702 generates a predictive model SM(u, v) corresponding to an imaging spectrum absolute value AS(u, v) (S804). The apparatus uses the actual distance of an object, model parameters, and noise parameters which are set in the above manner. The spectrum model generation unit 702 obtains an imaging parameter from the imaging parameter storage unit 705, and obtains an OFT corresponding to the obtained imaging parameter and the actual distance of an object from the optical characteristic information storage unit 706.

The predictive model SM(u, v) corresponding to a given imaging parameter and the actual distance d of the object multiplies the imaging spectrum absolute value AS_{org}(u, v) before blurring by the absolute value M(u, v) of the OTF corresponding to the imaging parameter and the actual distance d of the object. For example, the predictive model SM(u, v) is obtained by obtaining the noise N corresponding to an ISO sensitivity as an imaging parameter from the noise statistical model storage unit 704 and adding the noise N to the product. In step S803, multiplying a block Iⱼ(x, y) by a window function W(x, y) may increase the blur of the spectrum. In this case, in addition to the above processing, the apparatus performs convolution by Fourier transform F[W(x, y)] of the window function W(x, y)

Evaluation Function Generation Unit

The evaluation function generation unit 707 compares the imaging spectrum absolute value ASⱼ(x, y) with the predictive model SMⱼ(u, v) generated by the spectrum model generation unit 702. As this comparison, the apparatus uses comparison based on an approximate evaluation function. In faithful consideration of an imaging process, it is possible to construct a strict evaluation function based on Bayesian statistics and use it.

In a frequency region in which a signal term AS_{org}(u, v)M(u, v) is larger than the noise N, the apparatus calculates the logarithms of ASⱼ(u, v) and SMⱼ(u, v), and obtains D(u, v) by dividing the square of the difference between the logarithms by a variance σm² of the statistical model. In contrast, in a frequency region in which a signal term AS_{org}(u, v)M(u, v) is equal to or less than the noise N, the apparatus obtains D(u, v) by dividing the square of the difference between ASⱼ(u, v) and SMⱼ(u, v) by a variance σₙ² of the noise model. The apparatus then obtains, as an evaluation function E, the sum total of D(u, v) throughout the entire frequency region:

if (AS_{org}(u,v)M(u,v)>N)

D(u,v)=[{log ASⱼ(u,v)−log SMⱼ(u,v)}2/σₘ²];

else

D(u,v)=[{ASⱼ(u,v)−SMⱼ(u,v)}2/σₙ²];

E=ΣᵤΣᵥD(u,v); (3)

The evaluation function E uses an approximation that there are few frequency regions in which noise competes against signal, relative to the strict evaluation function based on Bayesian statistics. In other words, most frequency regions are approximately regarded as regions in which signal dominates or noise dominates. If there is a possibility that this approximation may collapse, it is possible to use the strict evaluation function for an assumed statistical model.

The evaluation function E indicates the degree of match between the imaging spectrum absolute value ASⱼ(u, v) and the predictive model SMⱼ(u, v). In addition, the evaluation function E is a function of the model parameters γ and k₀, noise parameter N, and the actual distance d of the object.

The spectrum model generation unit 702 and the evaluation function generation unit 707 repeatedly generate the evaluation function E with respect to all the parameters in the above procedure. The distance candidate determination unit 708 extracts the evaluation function E whose value is minimum (the degree of match between ASⱼ(u, v) and SMⱼ(u, v) is maximum) at positions corresponding to distances shorter and longer than the object distance df. This processing is a so-called optimization problem, and it is possible to extract the evaluation function E by using a known method such as a method of steepest descent. The distance candidates d_{B} and d_{B} are the actual distances d of the object which are used to obtain OTFs when the predictive model SMⱼ(u, v) corresponding to the two extracted evaluation functions E is generated.

If, for example, the image sensing device 110 has a Bayer arrangement and the actual distance of an object is estimated from the captured image represented by RAW data before demosaicing, it is possible to perform distance estimation processing by using G signals from many image sensing elements. Alternatively, it is possible to add (or weight and add) R, G, and B signals from one image sensing element for R, one image sensing element for B, and two image sensing elements for G which are adjacent to each other (these four pixels are arranged in, for example, a square form) and perform distance estimation processing using the addition value as a signal value from one pixel.

In this manner, it is possible to accurately estimate the actual distances of all objects from one captured image without limiting the actual distance of the object to either of distances shorter or longer than the object distance.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-277425, filed Dec. 13, 2010, which is hereby incorporated by reference herein in its entirety.

What is claimed is:

1. An image processing apparatus comprising:
an inputting section, configured to input image capturing data captured by using an imaging optical system including an iris with an aperture having no point symmetry;
an obtaining section, configured to obtain an imaging parameter for the imaging optical system when the image capturing data is captured;
a calculator, configured to calculate a spectrum of the input image capturing data;
a storing section, configured to store optical characteristic information of the imaging optical system and a spectrum model of image capturing data;
a model generator, configured to generate a predictive model as a spectrum model corresponding to the input image capturing data by using the imaging parameter, optical characteristic information corresponding to the imaging parameter and an object distance, and the spectrum model;
a function generator, configured to generate an evaluation function by using the spectrum of the image capturing data and the predictive model; and
an estimator, configured to estimate an actual distance of the object included in an image represented by the image capturing data by using the evaluation function and a statistical method.

2. The apparatus according to claim 1, wherein the estimator comprises:
an extractor, configured to extract an evaluation function whose value is minimum at positions corresponding to distances shorter and longer than the object distance represented by the imaging parameter; and
a determiner, configured to determine, as a plurality of distance candidates corresponding to actual distances of the object included in the image, object distances obtained when a predictive model used for generation of the extracted evaluation function is generated.

3. The apparatus according to claim 2, wherein the estimator further comprises:
a restoring section, configured to restore a blur of a spectrum of the image capturing data by using optical characteristic information corresponding to each of the plurality of distance candidates; and
a computation section, configured to calculate an autocorrelation of a phase of a spectrum of image capturing data after the restoration.

4. The apparatus according to claim 3, wherein the estimator determines one of the plurality of distance candidates as an estimated value of an actual distance of the object by using an autocorrelation calculated for each of the plurality of distance candidates.

5. The apparatus according to claim 1, wherein the storing section further stores a noise characteristic of image capturing data, and the model generator adds noise represented by a noise characteristic corresponding to the imaging parameter to the predictive model.

6. An image processing method comprising using a processor to perform the steps of:
inputting image capturing data captured by using an imaging optical system including an iris with an aperture having no point symmetry;
obtaining an imaging parameter for the imaging optical system when the image capturing data is captured;
calculating a spectrum of the input image capturing data;
storing optical characteristic information of the imaging optical system and a spectrum model of image capturing data;
generating a predictive model as a spectrum model corresponding to the input image capturing data by using the imaging parameter, optical characteristic information corresponding to the imaging parameter and an object distance, and the spectrum model;
generating an evaluation function by using the spectrum of the image capturing data and the predictive model; and
estimating an actual distance of the object included in an image represented by the image capturing data by using the evaluation function and a statistical method.

7. A non-transitory computer readable medium storing a computer-executable program for causing a computer to perform an image processing method comprising the steps of:
inputting image capturing data captured by using an imaging optical system including an iris with an aperture having no point symmetry;
obtaining an imaging parameter for the imaging optical system when the image capturing data is captured;
calculating a spectrum of the input image capturing data;
storing optical characteristic information of the imaging optical system and a spectrum model of image capturing data;
generating a predictive model as a spectrum model corresponding to the input image capturing data by using the imaging parameter, optical characteristic information corresponding to the imaging parameter and an object distance, and the spectrum model;
generating an evaluation function by using the spectrum of the image capturing data and the predictive model; and
estimating an actual distance of the object included in an image represented by the image capturing data by using the evaluation function and a statistical method.
